(19) United States
(12) Patent Application Publication
(10) Pub. No.: US 2026/0138882 A1
(43) Pub. Date: May 21, 2026

(54) ACTIVE MATERIAL SECONDARY PARTICLE AND METHOD FOR MANUFACTURING ACTIVE MATERIAL SECONDARY PARTICLE

(71) Applicant: TOYOTA JIDOSHA KABUSHIKI KAISHA, Toyota-shi (JP)

(72) Inventor: Shin USHIRODA, Susono-shi (JP)

(73) Assignee: TOYOTA JIDOSHA KABUSHIKI KAISHA, Toyota-shi (JP)

(21) Appl. No.: 19/292,395

(22) Filed: Aug. 6, 2025

(30) Foreign Application Priority Data
Nov. 21, 2024 (JP) 2024-203218

(51) Int. Cl. C01G 45/1228

(52) U.S. Cl. CPC C01G 45/1228; C01P 2002/52; C01P 2004/03; C01P 2004/61; C01P 2006/40

(57) ABSTRACT

An active material secondary particle of the present disclosure includes a plurality of primary particles. Each of the primary particles has a P2-type structure. Each of the primary particles contains, as constituent elements, at least Na, a first dopant element, a transition metal element, a second dopant element, and O. The first dopant element is Ca. The first dopant element is contained in a Na layer of the P2-type structure. The transition metal element includes one or both of Mn and Ni. The second dopant element is one or more of B, Mg, and Al. The second dopant element is contained in a transition metal element layer of the P2-type structure. The primary particles have an average particle size of 2.0 μm or less.

### CROSS-REFERENCE TO RELATED APPLICATION

This application claims priority to Japanese Patent Application No. 2024-203218 filed on Nov. 21, 2024. The disclosure of the above-identified application, including the specification, drawings, and claims, is incorporated by reference herein in its entirety.

### BACKGROUND

### 1. Technical Field

The present application discloses active material secondary particles and methods for manufacturing an active material secondary particle.

### 2. Description of Related Art

Japanese Unexamined Patent Application Publication No. 2023-182443 (JP 2023-182443 A) discloses a cathode active material with a P2-type structure for use in sodium-ion batteries.

### SUMMARY

Conventional cathode active materials with a P2-type structure have room for improvement in terms of resistance.

The present application discloses the following aspects to address the above issue.

### First Aspect

An active material secondary particle includes a plurality of primary particles.

Each of the primary particles has a P2-type structure.

Each of the primary particles contains at least the following elements as constituent elements:
Na,
a first dopant element,
a transition metal element,
a second dopant element, and
O.

The first dopant element is Ca.

The first dopant element is contained in a Na layer of the P2-type structure.

The transition metal element includes one or both of Mn and Ni.

The second dopant element is one or more of B, Mg, and Al.

The second dopant element is contained in a transition metal element layer of the P2-type structure.

The primary particles have an average particle size of 2.0 μm or less.

### Second Aspect

In the active material secondary particle according to the first aspect, each of the primary particles has a chemical composition represented by

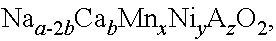

where

$$0 < a < 0.80 ,$$

$$0 < b \leq 0.08 ,$$

$$0.5 \leq x \leq 0.70 ,$$

$$0.3 \leq y \leq 0.50 ,$$

$$0 < z \leq 0.2 ,$$

and
A is one or more of B, Mg, and Al.

### Third Aspect

In the active material secondary particle according to the first or second aspect,
the mole ratio of the first dopant element to O in the primary particles is greater than zero and less than or equal to 0.04, and
the mole ratio of the second dopant element to O in the primary particles is greater than zero and less than or equal to 0.10.

### Fourth Aspect

In the active material secondary particle according to any one of the first to third aspects, the second dopant element is Mg.

### Fifth Aspect

A method for manufacturing an active material secondary particle includes:
obtaining precursor particles by coprecipitation;
mixing the precursor particles, a Na compound, a first dopant element compound, and a second dopant element compound to obtain a mixture; and
firing the mixture to obtain the active material secondary particle including a plurality of primary particles.

The precursor particles contain one or both of Mn and Ni.

The first dopant element compound is a Ca compound.

The second dopant element compound is a compound containing one or more of B, Mg, and Al.

Each of the primary particles has a P2-type structure.

The primary particles have an average particle size of 2.0 μm or less.

The active material secondary particle of the present disclosure has low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example flow of a method for manufacturing an active material secondary particle;

FIG. 2 schematically shows an example of the configuration of a battery; and

FIG. 3 shows scanning electron microscope (SEM) images of cathode active materials of Example 1 and Comparative Examples 1 to 3.

### DETAILED DESCRIPTION OF EMBODIMENTS

### 1. Active Material Secondary Particle

An active material secondary particle according to an embodiment contains a plurality of primary particles. Each of the primary particles has a P2-type structure. Each of the primary particles contains, as constituent elements, at least Na, a first dopant element, a transition metal element, a second dopant element, and O. The first dopant element is Ca. The first dopant element is contained in a Na layer of the P2-type structure. The transition metal element includes one or both of Mn and Ni. The second dopant element is one or more of B, Mg, and Al. The second dopant element is contained in a transition metal element layer of the P2-type structure. The primary particles have an average particle size of 2.0 μm or less.

### 1.1 Crystal Structure

The primary particles contained in the active material secondary particle have at least a P2-type structure (belonging to the space group P63mc) as a crystal structure. The primary particles may have a crystal structure other than the P2-type structure, in addition to the P2-type structure. Examples of crystal structures other than the P2-type structure include various crystal structures (such as a P3-type structure) that are formed when Na is extracted from or inserted into the P2-type structure. The primary particles may have the P2-type structure as a main phase. The main-phase crystal structure of the primary particles may change depending on the charge or discharge state. The active material secondary particle may be an aggregate of a plurality of single-crystal particles having the P2-type structure, or may be an aggregate of a plurality of polycrystalline particles having the P2-type structure. The P2-type structure belongs to the hexagonal crystal system and has a high Na-ion diffusion coefficient. Crystal growth of the P2-type structure tends to occur along a specific crystallographic direction. Therefore, a crystallite having the P2-type structure may grow preferentially along a specific crystallographic direction (e.g., in the form of a plate). In this case, the end of this crystallite having the P2-type structure (the end in the crystal growth direction) may serve as the entry and exit points for intercalation.

### 1.2 Chemical Composition

The primary particles contained in the active material secondary particle contain, as constituent elements, at least Na, a first dopant element, a transition metal element, a second dopant element, and O. In other words, the primary particles are composite oxides that contain, as constituent elements, at least Na, a first dopant element, a transition metal element, a second dopant element, and O. The first dopant element is Ca. The first dopant element is contained in the Na layer of the P2-type structure. The transition metal element includes one or both of Mn and Ni. In particular, when the transition metal element includes both Mn and Ni, higher performance is more likely to be achieved. The second dopant element is one or more of B, Mg, and Al. The second dopant element is contained in the transition metal element layer of the P2-type structure. The primary particles may contain, as a constituent element, a third dopant element that is different from the first dopant element and the second dopant element. The type of the third dopant element is not particularly limited as long as the P2-type structure can be maintained.

The primary particles contain Na as a constituent element. The amount of Na contained in the primary particles is not particularly limited as long as the P2-type structure is maintained. For example, the mole ratio of Na to O (Na/O) in the primary particles may be greater than zero, 0.10 or more, 0.20 or more, 0.30 or more, 0.40 or more, 0.50 or more, or 0.60 or more, and may be 1.40 or less, 1.30 or less, 1.20 or less, 1.10 or less, 1.00 or less, 0.90 or less, or less than 0.80. In particular, when the mole ratio of Na to O in the primary particles is greater than zero and less than 0.80, particularly when this mole ratio is greater than or equal to 0.60 and less than 0.80, high capacity is more likely to be achieved.

The primary particles contain Ca as the first dopant element. The first dopant element, Ca, may be doped into the Na layer of the P2-type structure. In conventional P2-type Na-containing composite oxides, the Na layer of the P2-type structure collapses after Na is extracted. This results in a reduction in the amount of subsequent Na insertion and extraction and a deterioration in cycle characteristics. In addition, as far as the inventors have confirmed, even when the amount of Na contained in a Na-containing oxide is increased, sufficient capacity may not be obtained. In contrast, in the present embodiment, Ca is contained in the Na layer of the P2-type structure, and the Ca functions as a pillar. Therefore, collapse of the Na layer is more likely to be reduced even after Na is extracted, making it easier to achieve excellent cycle characteristics. Since the Ca functions as a pillar and collapse of the Na layer is reduced, the amount of Na insertion and extraction is increased. As a result, high capacity can be achieved. The amount of the first dopant element contained in the primary particles is not particularly limited, and may be adjusted as appropriate according to the intended performance of the active material. For example, the mole ratio of the first dopant element to O (first dopant element/O) in the primary particles may be greater than zero and less than or equal to 0.10, may be greater than zero and less than or equal to 0.08, may be greater than zero and less than or equal to 0.06, or may be greater than zero and less than or equal to 0.04. In particular, when the mole ratio of the first dopant element to O (first dopant element/O) in the primary particles is greater than zero and less than or equal to 0.04, higher capacity is more likely to be achieved along with excellent cycle characteristics.

The primary particles contain one or both of Mn and Ni as the transition metal element. In particular, when the primary particles contain both Mn and Ni as the transition metal element, higher performance is more likely to be achieved. The transition metal element contained in the primary particles may be either Mn or Ni, or both. The amount of the transition metal element contained in the primary particles is not particularly limited as long as the P2-type structure is maintained. For example, the mole ratio of the transition metal element to O (transition metal element/O) in the primary particles may be greater than or equal to 0.40 and less than or equal to 0.60, or may be greater than or equal to 0.45 and less than or equal to 0.55.

The primary particles contain one or more of B, Mg, and Al as the second dopant element. The second dopant element is doped into the transition metal element layer of the P2-type structure. Since the second dopant element is contained in the transition metal element layer of the P2-type structure, the P2-type structure is stabilized, and dissolution of the transition metal element etc. during Na extraction is reduced. As a result, high capacity is more likely to be achieved. In particular, since Mg, like Mn or Ni, tends to bond with O to form an octahedral structure, Mg is considered to be appropriately doped into the transition metal element layer of the P2-type structure, thereby more appropriately reducing the dissolution of the transition metal element during Na extraction. Accordingly, when the second dopant element contained in the primary particles is Mg, high capacity and excellent cycle characteristics are more likely to be achieved. The amount of the second dopant element contained in the primary particles is not particularly limited, and may be adjusted as appropriate according to the intended performance of the active material. For example, the mole ratio of the second dopant element to O (second dopant element/O) in the primary particles may be greater than zero and less than or equal to 0.20, may be greater than zero and less than or equal to 0.18, may be greater than zero and less than or equal to 0.16, may be greater than zero and less than or equal to 0.14, may be greater than zero and less than or equal to 0.12, or may be greater than zero and less than or equal to 0.10. In particular, when the mole ratio of the second dopant element to O (second dopant element/O) in the primary particles is greater than zero and less than or equal to 0.10, higher capacity is more likely to be achieved along with excellent cycle characteristics.

The primary particles may have a chemical composition represented by Na_{a-2b}Ca_{b}MnₓNi_{y}A_{z}O₂ (where 0<a<0.80, 0<b≤0.08, 0.50≤x≤0.70, 0.30≤y≤0.50, 0<z≤0.20, and A is the second dopant element, i.e., one or more of B, Mg, and Al). In this chemical composition, a is greater than zero and less than 0.80, and may be 0.10 or more, 0.20 or more, 0.30 or more, 0.40 or more, 0.50 or more, or 0.60 or more, b is greater than zero and less than or equal to 0.08, and may be 0.01 or more, 0.02 or more, 0.03 or more, 0.04 or more, 0.05 or more, 0.06 or more, or 0.07 or more, x is greater than or equal to 0.50 and less than or equal to 0.70, and may be 0.55 or more, 0.60 or more, or 0.65 or more, y is greater than or equal to 0.30 and less than or equal to 0.50, and may be 0.45 or less, 0.40 or less, or 0.35 or less, and z is greater than zero and less than or equal to 0.20, may be 0.01 or more, 0.03 or more, 0.05 or more, 0.07 or more, or 0.09 or more, and may be 0.19 or less, 0.17 or less, 0.15 or less, 0.13 or less, or 0.11 or less. For example, x+y+z may be 1. The composition of O is 2, but may not be exactly 2.0.

### 1.3 Average Particle Size of Primary Particles

In the active material secondary particle according to the embodiment, the average particle size of the primary particles is 2.0 μm or less. The average particle size of the primary particles may be 1.9 μm or less, 1.8 μm or less, 1.7 μm or less, 1.6 μm or less, or 1.5 μm or less. The lower limit of the average particle size of the primary particles is not particularly limited, and may be greater than 0 μm, 0.1 μm or more, 0.2 μm or more, 0.3 μm or more, 0.4 μm or more, 0.5 μm or more, 0.6 μm or more, 0.7 μm or more, 0.8 μm or more, 0.9 μm or more, 1.0 μm or more, 1.1 μm or more, 1.2 μm or more, 1.3 μm or more, 1.4 μm or more, or 1.5 μm or more. The active material secondary particle according to the embodiment can be regarded as an aggregate of fine primary particles having an average particle size of 2.0 μm or less. Forming the secondary particle by close aggregation of a plurality of fine primary particles is considered to facilitate formation of ion conduction paths and reduction in resistance. According to a new finding by the inventors, when a P2-type Na-containing composite oxide containing both of the above first and second dopant elements as constituent elements is obtained, a secondary particle that is such an aggregate of a plurality of fine primary particles is more likely to be formed. In this case, each of the primary particles may be, for example, in the form of a plate. If the primary particles do not contain the first dopant element and the second dopant element simultaneously, the primary particles are more likely to be spherical and to have an average particle size greater than 2.0 μm. The average particle size of the primary particles constituting the active material secondary particle is measured as follows. An image of the appearance of the active material secondary particle is acquired using a transmission electron microscope (TEM), a scanning electron microscope (SEM), etc. For each of 10 or more arbitrary primary particles included in the image, the diameter of a circle having the same area as the area of that primary particle obtained from the image (equivalent circle diameter) is determined. The arithmetic mean of the equivalent circle diameters of the primary particles is regarded as the “average particle size of the primary particles.”

### 1.4 Others

The number of primary particles contained in the active material secondary particle according to the embodiment is not particularly limited. The number of primary particles contained in the active material secondary particle may be 10 or more, 20 or more, 30 or more, 40 or more, or 50 or more. The overall shape of the active material secondary particle is not particularly limited. The overall shape of the active material secondary particle may be non-spherical. In the present application, the term “non-spherical secondary particle” refers to a secondary particle having a circularity of less than 0.80 when observed externally. The circularity of a secondary particle is defined as 4πS/L², where S represents the orthographically projected area of the secondary particle, and L represents the perimeter of the orthographically projected image of the secondary particle. The circularity of a secondary particle can be determined by observing the appearance of the particle with an SEM, a TEM, or an optical microscope. The overall size of the active material secondary particle (secondary particle size) is not particularly limited. The secondary particle size of the active material secondary particle may be greater than 1.5 μm and less than or equal to 100 μm, may be greater than 2.0 μm and less than or equal to 100 μm, may be greater than 2.0 μm and less than or equal to 50 μm, or may be greater than 2.0 μm and less than or equal to 20 μm. The secondary particle size of the active material secondary particle is measured as follows. An image of the appearance of the active material secondary particle is acquired using a TEM, an SEM, etc. For the active material secondary particle included in the image, the diameter of a circle having the same area as the area of the active material secondary particle obtained from the image (equivalent circle diameter) is determined. This equivalent circle diameter is regarded as the “secondary particle size of the active material secondary particle.”

### 2. Method for Manufacturing Active Material Secondary Particle

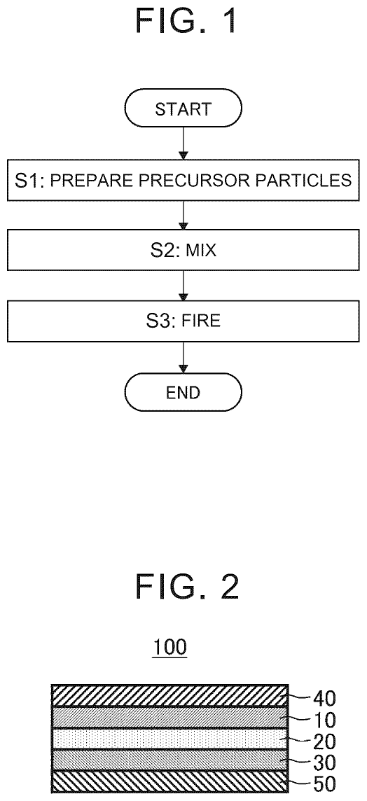

As shown in FIG. 1, a method for manufacturing an active material secondary particle according to the embodiment includes:
S1: obtaining precursor particles by coprecipitation;
S2: mixing the precursor particles, a Na compound, a first dopant element compound, and a second dopant element compound to obtain a mixture; and
S3: firing the mixture to obtain the active material secondary particle containing a plurality of primary particles.

The precursor particles contain one or both of Mn and Ni.

The first dopant element compound is a Ca compound.

The second dopant element compound is a compound containing one or more of B, Mg, and Al.

Each of the primary particles has a P2-type structure.

The average particle size of the primary particles is 2.0 μm or less.

### 2.1 S1

In S1, precursor particles are obtained by coprecipitation. For example, a precipitate serving as a precursor is obtained by coprecipitation using an ion source that can form a precipitate with transition metal ions in an aqueous solution, and a transition metal compound containing one or both of Mn and Ni. The “ion source that can form a precipitate with transition metal ions in an aqueous solution” may be, for example, at least one selected from sodium salts such as sodium carbonate and sodium nitrate, sodium hydroxide, and sodium oxide. The transition metal compound may be a salt or hydroxide containing one or both of Mn and Ni. Specifically, in S1, a precipitate serving as a precursor may be obtained by preparing a solution of the ion source and a solution of the transition metal compound, and then dropwise adding and mixing these solutions. For example, water is used as the solvent. Various sodium compounds may be used as bases, and an aqueous ammonia solution etc. may be added to adjust the basicity. In S1, the precursor particles may be salts containing at least one of Mn and Ni. For example, the precursor particles may be at least one selected from carbonates, sulfates, nitrates, and acetates. Alternatively, the precursor particles may be compounds other than salts. For example, the precursor particles may be hydroxides. The precursor particles may be hydrates. The precursor particles may be a combination of a plurality of types of compounds. The composition of the precursor particles may be determined as appropriate so as to correspond to the composition of the final product, namely a P2-type Na-containing composite oxide.

### 2.2 S2

In S2, the precursor particles obtained in S1, a Na compound, a first dopant element compound, and a second dopant element compound are mixed to obtain a mixture. In S2, the Na compound may be, for example, a salt such as a carbonate or a sulfate, or may be a compound other than a salt such as sodium oxide or sodium hydroxide. In one embodiment, the Na compound may be sodium carbonate. In S2, the first dopant element compound is a Ca compound. For example, the Ca compound may be a salt such as a carbonate or a sulfate, or may be a compound other than a salt such as calcium oxide or calcium hydroxide. In one embodiment, the Ca compound may be one or both of calcium oxide and calcium hydroxide. In S2, the second dopant element compound is a compound containing one or more of B, Mg, and Al. For example, the second dopant element compound may be a salt such as a carbonate or a sulfate containing one or more of B, Mg, and Al, or may be a compound other than a salt such as an oxide or a hydroxide containing one or more of B, Mg, and Al. In one embodiment, the second dopant element compound may be one or both of an oxide and a hydroxide containing one or more of B, Mg, and Al.

In S2, at least the precursor particles, the Na compound, the first dopant element compound, and the second dopant element compound are mixed to obtain a solid mixture containing these components. The means for mixing the precursor particles, the Na compound, the first dopant element compound, and the second dopant element compound is not particularly limited. These components may be mixed manually using a mortar etc., or may be mixed mechanically using various mixing devices. In S2, the mixing ratio of the precursor particles, the Na compound, the first dopant element compound, and the second dopant element compound may be determined as appropriate in accordance with the composition of the final product, namely the P2-type Na-containing composite oxide. For example, the amount of the Na compound to be mixed with the precursor particles may be determined in consideration of the amount of Na loss during subsequent firing.

### 2.3 S3

In S3, the mixture obtained in S2 is fired to obtain an active material secondary particle including a plurality of primary particles. Each of the primary particles is a Na-containing composite oxide having a P2-type structure. That is, in the present embodiment, the active material secondary particle can be obtained by a so-called solid-phase method. S3 may include optionally shaping the mixture and optionally subjected it to pre-firing before main firing is performed. The firing conditions in S3 may be any conditions that allow a plurality of primary particles having an average particle size of 2.0 μm or less to aggregate and form the active material secondary particle. As described above, when the mixture contains both the first dopant element and the second dopant, the active material secondary particle obtained by firing is more likely to be an aggregate of a plurality of primary particles having an average particle diameter of 2.0 μm or less. The first dopant element and the second dopant element are considered to affect crystal growth and crystallinity of the P2-type structure.

In S3, the method for shaping the mixture is not particularly limited. The mixture may be shaped into pellets by known shaping means.

In S3, the pre-firing of the mixture may be performed at a temperature lower than or equal to the temperature of the main firing. For example, the pre-firing may be performed at a temperature below 700° C. The pre-firing time is not particularly limited. Alternatively, the pre-firing may be omitted.

In S3, the main firing of the mixture may be performed at a temperature of, for example, 700° C. or higher and 1100° C. or lower. Preferably, the temperature is greater than or equal to 800° C. and less than or equal to 1000° C. If the main firing temperature is too low, the P2-type structure may not be sufficiently formed. If the main firing temperature is too high, a crystal structure other than the P2-type structure (for example, an O3-type structure) is more likely to be formed. The conditions for heating from the pre-firing temperature to the main firing temperature are not particularly limited. The main firing time is also not particularly limited, and may be, for example, greater than or equal to 30 minutes and less than or equal to 10 hours. The atmosphere for the main firing is not particularly limited, and may be, for example, an oxygen-containing atmosphere such as an air atmosphere, or an inert gas atmosphere. The cooling conditions after the main firing are not particularly limited.

### 3. Battery

A battery according to an embodiment includes the above active material secondary particle of the present disclosure. The active material secondary particle of the present disclosure can be employed as, for example, a cathode active material for a sodium-ion battery. As shown in FIG. 2, a battery 100 according to an embodiment includes a cathode active material layer 10, an electrolyte layer 20, and an anode active material layer 30. The cathode active material layer 10 contains the active material secondary particle of the present disclosure. The battery 100 may include a cathode current collector 40 and an anode current collector 50. The battery 100 may be a solid-state battery or a liquid-based battery. The term “solid-state battery” refers to a battery that includes a solid electrolyte and that may allow the presence of a liquid. The battery 100 may be an all-solid-state battery that contains substantially no liquid. The configuration of the battery may be the same as that of a conventional battery, except that the active material secondary particle of the present disclosure is used. Detailed description thereof will be omitted.

As described above, one embodiment of the active material secondary particle etc. of the present disclosure has been described. However, the active material secondary particle etc. of the present disclosure may be modified in various ways other than the above embodiment without departing from the spirit and scope of the disclosure. The technique of the present disclosure will be described in more detail below with reference to an example. However, the technique of the present disclosure is not limited to the following example.

### 1. Preparation of Cathode Active Material

### 1.1 Coprecipitation Synthesis of Precursor Particles

MnSO₄·5H₂O and NiSO₄·6H₂O were weighed in a ratio corresponding to a desired composition, and dissolved in distilled water to a concentration of 1.2 mol/L to obtain a first solution. In a separate container, Na₂CO₃ was dissolved in distilled water to a concentration of 1.2 mol/L to obtain a second solution. Subsequently, 500 mL of the first solution and 500 mL of the second solution were added dropwise, each at about 4 mL/min, into a reaction vessel pre-charged with 1000 mL of pure water. After completion of the dropwise addition, the resultant mixture was stirred at room temperature at 150 rpm for one hour. The resultant precipitate was washed with pure water and subjected to solid-liquid separation using a centrifuge. The precipitate thus obtained was dried overnight at 120° C. to obtain precursor particles containing Mn and Ni (Mn_{0.66}Ni_{0.34}CO₃).

1.2 Mixing of Precursor Particles with Na Compound etc.

### 1.2.1 Example 1

The above precursor particles, NaCO₃ as a Na compound, Ca(OH)₂ as a first dopant element compound, and Mg(OH)₂ as a second dopant element compound were mixed in a mortar to obtain a mixture.

### 1.2.2 Comparative Example 1

The above precursor particles and NaCO₃ were mixed in a mortar to obtain a mixture.

### 1.2.3 Comparative Example 2

The above precursor particles, NaCO₃, and Ca(OH)₂ were mixed in a mortar to obtain a mixture.

### 1.2.4 Comparative Example 3

The above precursor particles, NaCO₃, and Mg(OH)₂ were mixed in a mortar to obtain a mixture.

### 1.3 Firing of Mixture

The mixture was fired in an alumina crucible placed in an electric furnace under an air atmosphere (humidity: 50% or higher). Specifically, the mixture was shaped into pellets, and then subjected to the following steps as shown in Table 1: “first heating step,” “pre-firing step,” “second heating step,” “main firing step,” and “in-furnace cooling step.” Thereafter, the fired material was removed from the electric furnace at 250° C. A Na-containing oxide having a P2-type structure was thus obtained.

TABLE 1

| | Starting | Ending | | Heating or |
|---|---|---|---|---|
| | Temperature | Temperature | Time | Cooling Rate |
| Step | (° C.) | (° C.) | (min) | (° C./min) |
| First Heating | 25 | 600 | 115 | 5 |
| Step | | | | |
| Pre-Firing Step | 600 | 600 | 360 | 0 |
| Second Heating | 600 | 900 | 100 | 3 |
| Step | | | | |
| Main Firing | 900 | 900 | 60 | 0 |
| Step | | | | |
| In-Furnace | 900 | 250 | 130 | 5 |
| Cooling Step | | | | |

### 2. Identification of Chemical Composition of Cathode Active Material

The chemical compositions of the cathode active materials of Example 1 and Comparative Examples 1 to 3 were identified by ICP analysis etc. Table 2 shows the chemical compositions of these cathode active materials.

TABLE 2

| | | Dopant |
|---|---|---|
| | Chemical Composition | Elements |
| Example 1 | Na_{0.62}Ca_{0.075}(Mn_{0.66}Ni_{0.34})_{0.9}Mg_{0.1}O₂ | Ca and Mg |
| Comparative Example 1 | Na_{0.67}Mn_{0.66}Ni_{0.34}O₂ | None |
| Comparative Example 2 | Na_{0.62}Ca_{0.075}Mn_{0.66}Ni_{0.34}O₂ | Ca |
| Comparative Example 3 | Na_{0.67}(Mn_{0.66}Ni_{0.34})_{0.9}Mg_{0.1}O₂ | Mg |

### 3. Observation of Appearance of Cathode Active Material and Identification of Average Primary Particle Size

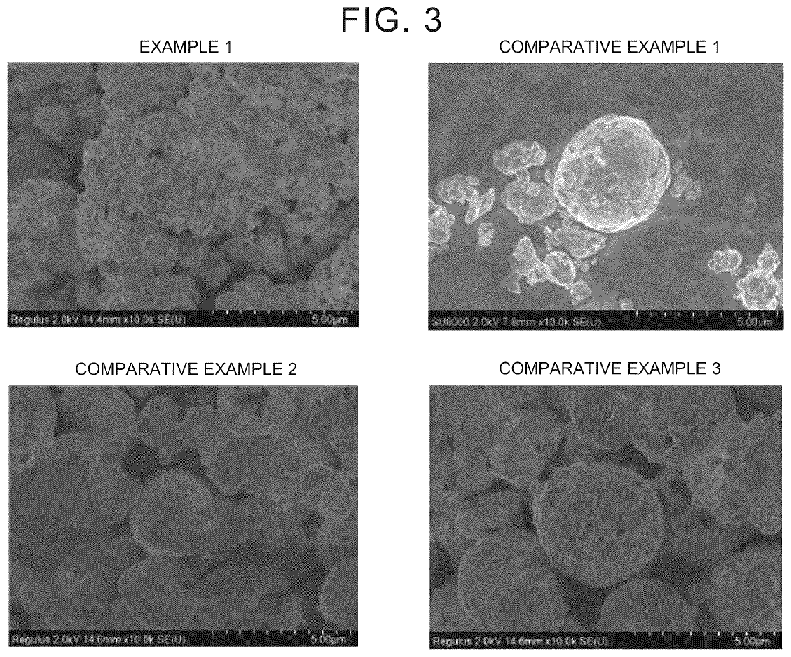

The appearance of each of the cathode active materials of Example 1 and Comparative Examples 1 to 3 was observed by SEM. FIG. 3 shows SEM images of the cathode active materials of Example 1 and Comparative Examples 1 to 3. As shown in FIG. 3, in the cathode active materials of Comparative Examples 1 to 3, the primary particles are spherical, and the spherical primary particles are not aggregated. On the other hand, the cathode active material of Example 1 is a secondary particle formed by aggregation of fine primary particles. Table 3 shows the average particle sizes of the primary particles of the cathode active materials of Example 1 and Comparative Examples 1 to 3. The method for measuring the average particle size of the primary particles is as described in the embodiment.

TABLE 3

| | | Average Primary Particle |
|---|---|---|
| | Dopant Elements | Size (μm) |
| Example 1 | Ca and Mg | 1.5 |
| Comparative Example 1 | None | 4.0 |
| Comparative Example 2 | Ca | 3.0 |
| Comparative Example 3 | Mg | 4.0 |

### 3. Electrochemical Measurement

### 3.1 Resistance

The above cathode active material, PVdF as a binder, and carbon as an electrically conductive additive were weighed in a mass ratio of 85:5:10 (cathode active material:PVdF:carbon), and dispersed and mixed in N-methyl-2-pyrrolidone to prepare a slurry. The slurry was coated onto Al foil, pressed, and then vacuum-dried at 120° C. overnight to obtain a cathode. A coin cell was fabricated using the cathode, Na metal foil as a counter electrode, and a 1 M solution of NaPF₆ in PC as an electrolytic solution. After one charge-discharge cycle of the coin cell at a rate of 0.1 C in the voltage range of 2.0 V to 4.5 V in a thermostatic chamber maintained at 25° C., impedance measurement was performed. The results are shown in Table 4.

TABLE 4

| | Dopant Elements | Impedance (Ω) |
|---|---|---|
| Example 1 | Ca and Mg | 197 |
| Comparative Example 1 | None | 435 |
| Comparative Example 2 | Ca | 229 |
| Comparative Example 3 | Mg | 204 |

The results in Table 4 indicate that the resistance is significantly reduced in a Ca- and Mg-doped Na-containing oxide having a P2-type structure. In a Ca- and Mg-doped Na-containing oxide having a P2-type structure, the cathode active material forms secondary particles that are aggregates of fine primary particles, as described above. This is considered to facilitate formation of ion conduction paths, thereby reducing the resistance.

### 3.2 First-Cycle Discharge Capacity

The coin cell was charged and discharged at a rate of 0.1 C in the voltage range of 2.0 V to 4.5 V in a thermostatic chamber maintained at 25° C., and the first-cycle discharge capacity was measured. The results are shown in Table 5.

TABLE 5

| | | Discharge Capacity |
|---|---|---|
| | Dopant Elements | (mAh/g) |
| Example 1 | Ca and Mg | 164.91 |
| Comparative Example 1 | None | 122.45 |
| Comparative Example 2 | Ca | 124.90 |
| Comparative Example 3 | Mg | 143.27 |

The results in Table 5 indicate that the discharge capacity is significantly increased in a Ca- and Mg-doped Na-containing oxide having a P2-type structure. Ca is considered to be contained in the Na layer of the P2-type structure. When Ca is contained in the Na layer of the P2-type structure, the Ca functions as a pillar. Therefore, collapse of the Na layer is more likely to be reduced even after Na is extracted. As a result, the amount of Na insertion and extraction increases, which is considered to contribute to high capacity. Mg is considered to be contained in the transition metal element layer of the P2-type structure. Since Mg is contained in the transition metal element layer of the P2-type structure, the P2-type structure is stabilized, and dissolution of the transition metal element etc. during Na extraction is reduced, which is considered to contribute to high capacity. That is, in Example 1, since both Ca and Mg are doped, they are considered to act synergistically to significantly increase the discharge capacity.

### 3.3 Capacity Retention Rate (Cycle Characteristics)

The coin cell was charged and discharged at a rate of 0.1 C in the voltage range of 2.0 V to 4.5 V in a thermostatic chamber maintained at 25° C., and the discharge capacity retention rates from the second to fifth cycles were measured, with the discharge capacity in the first cycle set as the reference (100%). The results are shown in Table 6.

TABLE 6

| | Example 1 | Comparative | Comparative | Comparative |
|---|---|---|---|---|
| | (Ca- and Mg- | Example 1 | Example 2 | Example 3 |
| | doped) | (Undoped) | (Ca-doped) | (Mg-doped) |
| First Cycle | 100 | 100 | 100 | 100 |
| Second Cycle | 99.3 | 96.2 | 99.2 | 99.0 |
| Third Cycle | 98.3 | 90.3 | 96.8 | 97.8 |
| Fourth Cycle | 97.3 | 84.2 | 94.6 | 96.5 |
| Fifth Cycle | 96.2 | 78.9 | 92.2 | 95.1 |

The results in Table 6 indicate that the cycle characteristics are significantly improved in a Ca- and Mg-doped Na-containing oxide having a P2-type structure. As described above, in a Ca- and Mg-doped Na-containing oxide having a P2-type structure, the Ca functions as a pillar. Therefore, collapse of the Na layer etc. is reduced even after Na is extracted, and the P2-type structure is appropriately maintained. In addition, Mg stabilizes the P2-type structure, and dissolution of the transition metal element etc. during Na extraction is reduced. These are considered to contribute to improved cycle characteristics.

### 4. Supplementary Information on Doping Sites of Ca and Mg

As described above, the cathode active material of Example 1 was obtained by adding a Na compound, a Ca compound, and a Mg compound to precursor particles containing Mn and Ni, and then firing the resultant mixture. When the Na compound and the dopant element compounds are thus mixed with the precursor particles after the precursor particles are obtained, and the resultant mixture is fired, it is considered that Mn, Ni, and Mg having similar ionic radii form the transition metal layer of the P2-type structure, while Na and Ca having similar ionic radii form the Na layer of the P2-type structure. If the precursor particles contain a dopant element in addition to Mn and Ni prior to mixing with the Na compound (i.e., if the precursor particles containing Mn, Ni, and a dopant element are obtained by coprecipitation), it is considered that the dopant element, together with Mn and Ni, forms the transition metal layer of the P2-type structure. The validity of the above considerations has been confirmed by obtaining an X-ray diffraction pattern of the cathode active material and identifying the interlayer distances of each layer by Rietveld analysis.

### 5. Supplementary Information on Dopant Elements Other Than Mg

The above example illustrates a cathode active material having a specific chemical composition. However, the chemical composition of the cathode active material is not limited to that described above. The inventors have confirmed that a cathode active material that is excellent in cycle characteristics etc. can be obtained even when B or Al is used as a dopant element instead of Mg (Japanese Patent Application No. 2024-129145). In other words, the same effects are considered to be achieved even when B or Al is doped in place of, or in combination with, Mg in Example 1. Moreover, the mole ratio of Na and the composition ratio of the transition metal element are not limited to those described above.

### 6. Summary

Based on the results of the example, it is considered that an active material secondary particle satisfying the following conditions (1) to (9) has low resistance and also has high capacity and excellent cycle characteristics.

(1) An active material secondary particle includes a plurality of primary particles.

(2) Each of the primary particles has a P2-type structure.

(3) Each of the primary particles contains, as constituent elements, at least Na, a first dopant element, a transition metal element, a second dopant element, and O.

(4) The first dopant element is Ca.

(5) The first dopant element is contained in the Na layer of the P2-type structure.

(6) The transition metal element includes one or both of Mn and Ni.

(7) The second dopant element is one or more of B, Mg, and Al.

(8) The second dopant element is contained in the transition metal element layer of the P2-type structure.

(9) The primary particles have an average particle size of 2.0 μm or less.

What is claimed is:

1. An active material secondary particle comprising a plurality of primary particles, wherein:
each of the primary particles has a P2-type structure;
each of the primary particles contains at least the following elements as constituent elements:
Na,
a first dopant element,
a transition metal element,
a second dopant element, and
O;
the first dopant element is Ca;
the first dopant element is contained in a Na layer of the P2-type structure;
the transition metal element includes one or both of Mn and Ni;
the second dopant element is one or more of B, Mg, and Al;
the second dopant element is contained in a transition metal element layer of the P2-type structure; and
the primary particles have an average particle size of 2.0 μm or less.

2. The active material secondary particle according to claim 1, wherein each of the primary particles has a chemical composition represented by 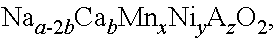
where
$$0 < a < 0.80 ,$$
$$0 < b \leq 0.08 ,$$
$$0.5 \leq x \leq 0.70 ,$$
$$0.3 \leq y \leq 0.50 ,$$
$$0 < z \leq 0.2 ,$$
and
A is one or more of B, Mg, and Al.

3. The active material secondary particle according to claim 1, wherein:
a mole ratio of the first dopant element to O in the primary particles is greater than zero and less than or equal to 0.04; and
a mole ratio of the second dopant element to O in the primary particles is greater than zero and less than or equal to 0.10.

4. The active material secondary particle according to claim 1, wherein the second dopant element is Mg.

5. A method for manufacturing an active material secondary particle, the method comprising:
obtaining precursor particles by coprecipitation;
mixing the precursor particles, a Na compound, a first dopant element compound, and a second dopant element compound to obtain a mixture; and
firing the mixture to obtain the active material secondary particle including a plurality of primary particles, wherein:
the precursor particles contain one or both of Mn and Ni;
the first dopant element compound is a Ca compound;
the second dopant element compound is a compound containing one or more of B, Mg, and Al;
each of the primary particles has a P2-type structure; and
the primary particles have an average particle size of 2.0 μm or less.
